(19) United States
(12) Patent Application Publication
(10) Pub. No.: US 2015/0102946 A1
(43) Pub. Date: Apr. 16, 2015

(54) SYSTEM AND METHOD FOR ENFORCING PARKING RULES

(71) Applicant: SAFER PLACE LTD., Tel-Aviv (IL)

(72) Inventor: Uri Kareev, Tel Aviv (IL)

(73) Assignee: SAFER PLACE LTD., Tel-Aviv (IL)

(21) Appl. No.: 14/511,650

(22) Filed: Oct. 10, 2014

Related U.S. Application Data
(60) Provisional application No. 61/889,039, filed on Oct. 10, 2013.

(51) Int. Cl. G08G 1/017

(52) U.S. Cl. CPC G08G 1/0175
USPC 340/932.2

(57) ABSTRACT

A method and system for enforcing parking rules are provided. The method includes receiving, from at least one source, a captured visual content showing a suspected vehicle and at least one potential sign of an illegally parked vehicle; identifying the at least one potential sign of an illegally parked vehicle in the captured visual content; determining whether the suspected vehicle is parked illegally respective of the at least one potential sign of an illegally parked vehicle and at least one parking rule; and upon determining that the suspected vehicle is parked illegally, sending a potential citation.

### CROSS-REFERENCE TO RELATED APPLICATIONS

This application claims the benefit of U.S. Provisional Application No. 61/889,039 filed on Oct. 10, 2013, the contents of which are hereby incorporated by reference.

### TECHNICAL FIELD

The present invention relates generally to parking monitoring systems, and more specifically to systems and methods for detecting and monitoring potential parking violations using image processing techniques.

### BACKGROUND

Camera-based traffic monitoring systems are often deployed by law enforcement inspectors to help enforce parking laws in an attempt to modify unsafe parking behavior and illegal parking. Although video footage and stills have been used for identification and prosecution of vehicles in violation of traffic laws, prior art solutions provide only partial solutions for traffic inspectors who are inspecting inappropriate parking due to the variety of parking authorizations currently available at restricted areas. Such authorizations may be given to, e.g., vehicles owned by handicapped people, law enforcement vehicles, vehicles owned by residents of a certain area, and cellular parking or smart terminals with a license plate-based payment. Furthermore, such authorizations may be subject to limitations such as time or date.

Specifically, the wide array of exceptions and authorizations to parking rules make it much more difficult for law enforcement officials to determine parking violations. As a result, law enforcement officials must either carefully check potential violations against existing parking rules or risk inadvertently punishing a citizen who has proper authorization. In particular, when parking laws change or when different rules are in effect at different times of the day or of the week, law enforcement officials may have difficulty determining which set of rules to apply at any given time.

It would therefore be advantageous to provide a solution for identifying potential traffic violations and verifying that a vehicle is indeed in violation of a traffic rule by verifying with an appropriate database.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all embodiments. Its sole purpose is to present some concepts of one or more embodiments in a simplified form as a prelude to the more detailed description that is presented later. For convenience, the term some embodiments may be used herein to refer to a single aspect or multiple embodiments of the disclosure.

The disclosure relates in various embodiments to a method for enforcing parking rules. The method comprises receiving, from at least one source, a captured visual content showing a suspected vehicle and at least one potential sign of an illegally parked vehicle; identifying the at least one potential sign of an illegally parked vehicle in the captured visual content; determining whether the suspected vehicle is parked illegally respective of the at least one potential sign of an illegally parked vehicle and at least one parking rule; and upon determining that the suspected vehicle is parked illegally, sending a potential citation.

The disclosure relates in various embodiments also relates to a system for enforcing parking rules. The system comprises a processor; and a memory, the memory containing instructions that, when executed by the processor, configure the system to: receive, from at least one source, a captured visual content showing a suspected vehicle and at least one potential sign of an illegally parked vehicle; identify the at least one potential sign of an illegally parked vehicle in the captured visual content; determine whether the suspected vehicle is parked illegally respective of the at least one potential sign of an illegally parked vehicle and at least one parking rule; and upon determination that the suspected vehicle is parked illegally, send a potential citation.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system utilized to discuss the disclosed embodiments;

FIG. 2 is a flowchart illustrating a method for enforcing parking rules according to an embodiment;

FIG. 3 is a flowchart illustrating a method for determining whether a parking violation has occurred according to an embodiment;

FIG. 4 is a flowchart illustrating a process for determining whether a vehicle may be parked illegally according to one embodiment; and

FIG. 5 is a flowchart illustrating a process for determining validation of potential citations according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

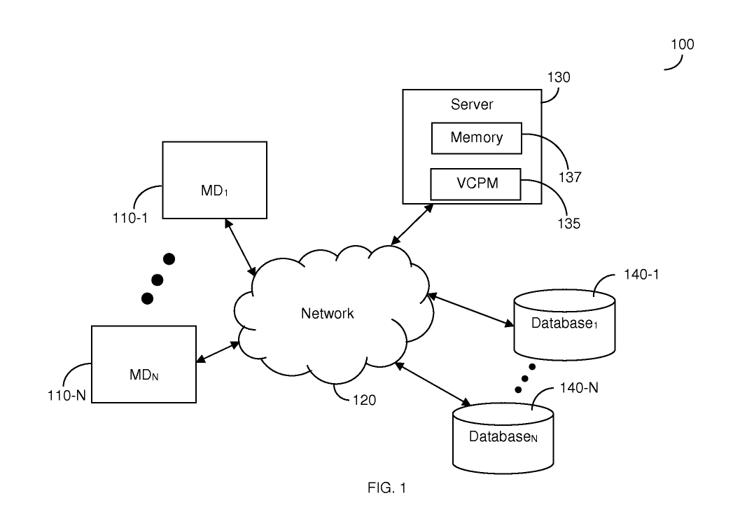

FIG. 1 shows an exemplary and non-limiting schematic block diagram of a network system 100 for utilized to describe the embodiments of determining traffic violations and in particular parking violations. The system 100 includes a plurality of mobile devices 110-1 through 110-N (hereinafter referred to collectively as mobile devices 110 or individually as a mobile device 110, merely for simplicity purposes) connected to a network 120 and communicatively connected to a server 130. The mobile devices 110 are typically operated by users, such as traffic inspectors or any other members of law enforcement to capture visual content. The mobile device 110 may be, but is not limited to, a smart phone, a mobile phone, a laptop, a tablet computer, a portable terminal device, a portable device and other kinds of wired and wireless appliances. The mobile devices 110 further include one or more image sensors capable of collecting visual content. The image sensors may be embedded in, for example, a still camera, a video camera, and so on.

The mobile device 110 typically further comprises a processor (not shown) or a processing unit, which is used to send the captured visual content through the network 120. According to one embodiment, a mobile device 110 is further configured with a global positioning system (GPS) which allows receiving and sending information related to the location of the mobile device 110 through the network 120. The GPS enables a mobile device 110 to receive directions from the server 130 in order to increase the performance of the system 100. The network 120 may be, but is not limited to, a local area network (LAN), a wide area network (WAN), a metro area network (MAN), the world wide web (WWW), the Internet, a wired network, a wireless network, and the like, as well as any combination thereof.

A server 130 is further communicatively connected to the network 120 and includes a visual content processing module (VCPM) 135 and a memory 137. In an embodiment, the memory 137 may contain instructions that, when executed by the server 130, configure the server 130 to determine parking violations as described further herein below.

A plurality of databases 140-1 through 140-N (hereinafter referred to collectively as databases 140 or individually as a database 140, merely for simplicity purposes) are further communicatively connected to the network 120, where N is an integer equal to ‘1’ or greater. The databases 140 contain information regarding vehicles' license plates' sets of characters to which the parking is freely allowed, or to which parking is allowed under restrictions in certain areas. The restrictions may be, but are not limited to, time, area, date, and so on. The server 130 by means of the VCPM 135 is configured to recognize at least one set of license plate characters shown in the visual content using image processing techniques. The server 130 is then configured to select at least one database of the one or more databases 140, for example, the database 140-1. The selection may be made based on the location in which the image of the vehicle license plate was captured. As an example, in case the parking area is in Brooklyn, New York, the municipal database of vehicles' license numbers owned by the residents of Brooklyn may be selected.

In an embodiment, the server 130 is further configured to check the database 140-1 to determine whether the recognized license plate relates to an illegally parked vehicle. Parking in an area in which the parking is at least partially restricted without having the required authentications is considered illegal parking. As an example, several parking areas may be restricted for a certain period of time, restricted to certain type of vehicles, and so on. In such areas, parking that does not meet all requirements is considered illegal. In that case, the server 130 is further configured to determine that the recognized license plate relates to an illegally parked vehicle and a potential citation respective of the vehicle is generated.

The VCPM 135 may comprise or be a component of a larger processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

According to another embodiment, the mobile devices 110 further comprise a memory unit (not shown). According to this embodiment, the mobile device 110 stores data extracted from the one or more databases 140 locally in the memory unit, thereby increasing the efficiency of accessing data by removing the need to access one or more of the databases 140. As an example, data related to vehicles that activated cellular parking services within the area of the mobile device 110-1 is extracted by the server 130 and send to the mobile device 110-1 in real-time such that this data may be used to assist in the determination of whether a vehicle is parking illegally.

According to another embodiment, the recognition of at least one set of license plate characters shown in the visual content, the selection of databases, and the determination of whether the recognized license plate relates to a vehicle parked illegally may all be made by the mobile device 110. According to this embodiment, the mobile device 110 includes a visual content processing unit such as the VCPM 135. Furthermore, the mobile device 110 may further include one or more databases from which at least one database is selected for the determination.

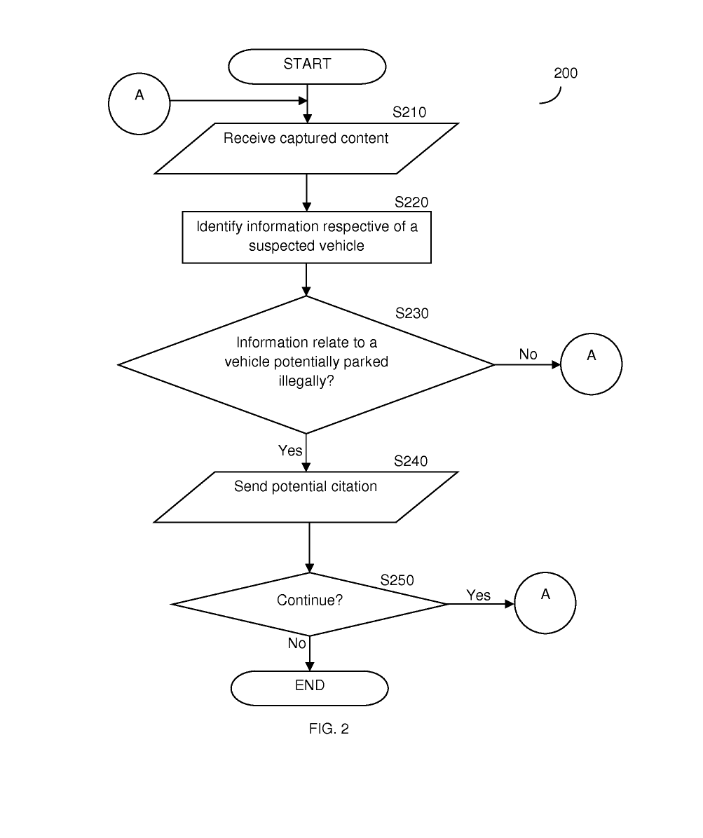

FIG. 2 depicts an exemplary and non-limiting flowchart 200 illustrating a method for enforcing parking rules in accordance with one embodiment. In S210, captured visual content is received from at least one mobile device, such as, for example, the mobile device 110. The visual content may be a still image, a video clip, and so on.

In S220, information respective of at least one suspected vehicle is identified. A suspected vehicle is a vehicle that may be in violation of a parking rule. In an embodiment, any vehicle that appears in the received visual content may be identified as a suspected vehicle. In another embodiment, only certain vehicles may be identified as suspected vehicles. For example, a car or a motorcycle may be identified suspected vehicles, but a bicycle may not be identified as a suspected vehicle. The identified information may be, for example, license plate characters of a suspected vehicle, the location in which the visual content was captured, and so on. The license plate's details may be recognized by the VCPM 135 using one or more image processing techniques, and more specifically one or more optical character recognition (OCR) techniques.

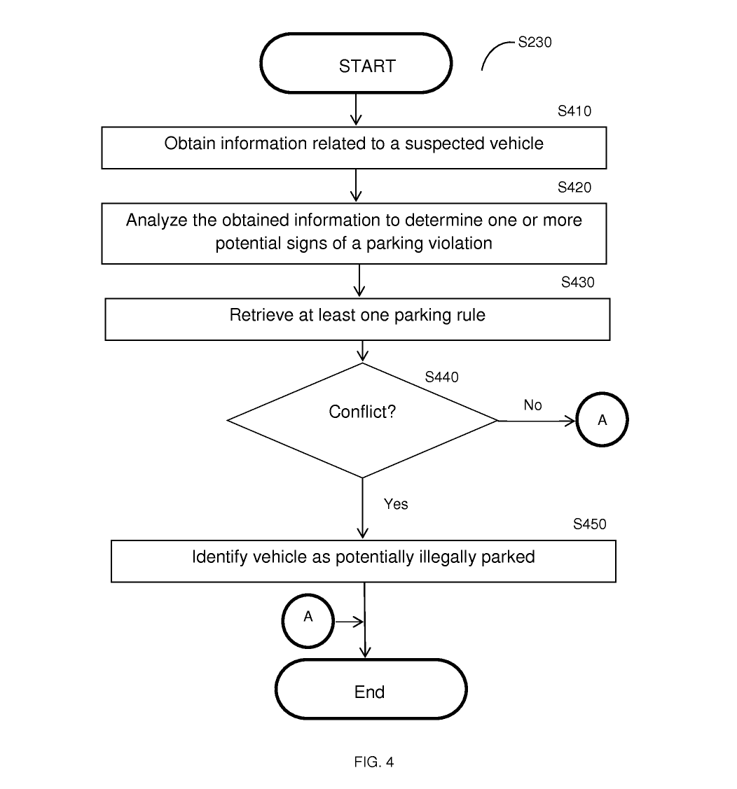

In S230, it is checked whether the suspected vehicle's information relates to a vehicle that may be parked illegally and, if so, execution continues with S240; otherwise, execution continues with S210. The check may be made against at least one database that contains information related to parking rules in place in one or more areas. In an embodiment, S230 may further include an additional check in which it is determined whether a parking authorization such as, for example, a valid parking ticket, a handicapped parking tag, and so on, related to the vehicle is found. In such an embodiment, if a vehicle is parked in a parking zone where an appropriate parking authorization may allow parking, identification of all relevant appropriate parking authorizations will result in a determination that the vehicle is not parked illegally. Determining whether a vehicle may be parked illegally is described further herein below with respect to FIG. 4.

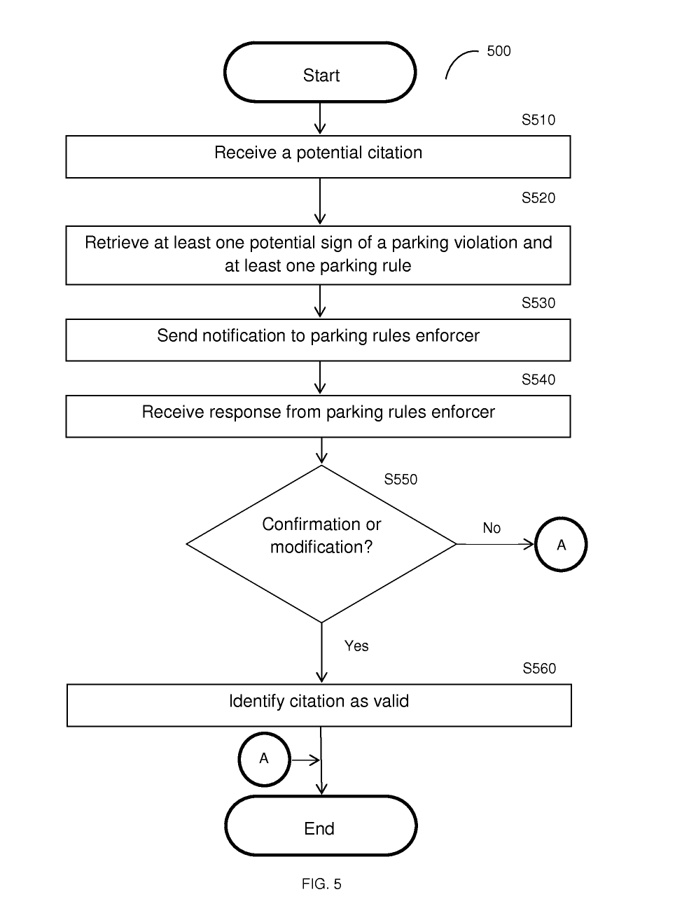

In S240, a potential citation is sent. In an embodiment, the potential citation may be sent directly to a mobile device 110 associated with a traffic inspector or any other member of law enforcement. In another embodiment, the potential citation, once approved, by for example, the traffic inspector, as a valid citation, is sent to an address associated with the illegally parked vehicle as is retrieved from at least one of the databases 140. Information related to the owner of the vehicle may be determined by, e.g., using a set of characters on the vehicle's license plate to search one or more databases (e.g., the databases 140) for registration information of the vehicle's owner. Validation of potential citations is described further herein below with respect to FIG. 5. In S250, it is checked whether additional content has been captured and, if so, execution continues with S210; otherwise, execution terminates.

As a non-limiting example, a video clip featuring a car being parked in a parking space of a “permit parking only” zone is received. Based on the video, information respective of the suspected violation is identified. In this example, the permit is supposed to be placed by the driver on the dashboard. Thus, a view of the dashboard lacking any permit and a sign indicating that the parking space is “permit parking only” are identified. Based on this identified information, it is determined that the information relates to a potentially illegally parked vehicle. Respective of the parking rule being broken, a proposed citation with a suggested fine of $50 is sent.

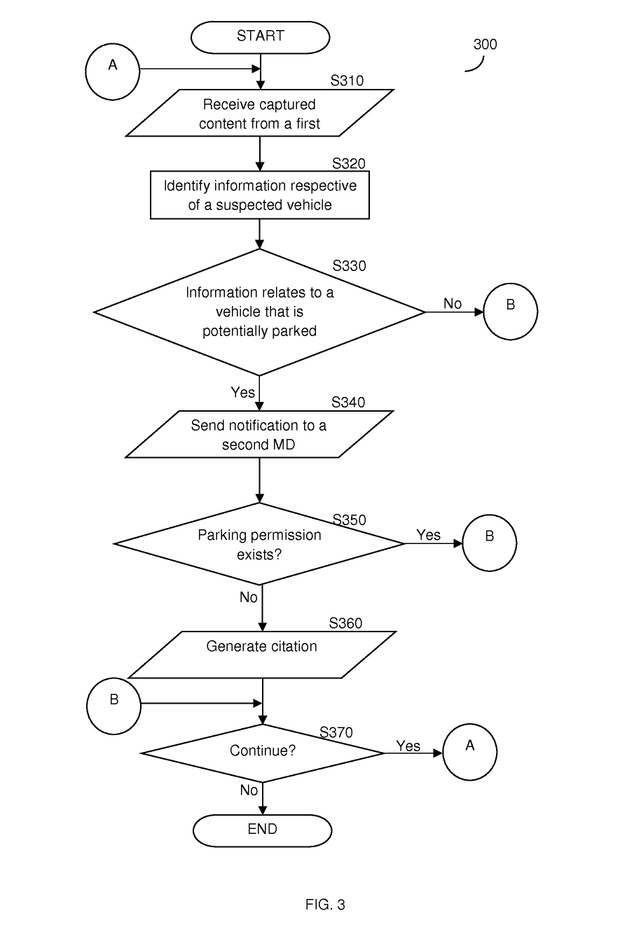

FIG. 3 depicts an exemplary and non-limiting flowchart 300 illustrating a method for determining whether a parking violation has occurred in accordance with another embodiment. In S310, captured visual content is received from a first mobile device such as, for example, the mobile device 110-1. In S320, information respective of at least one suspected vehicle is identified as described further herein above. The identified information may be, for example, license plate characters of a suspected vehicle, the location in which the visual content was captured, and so on.

In S330, it is checked whether the identified information relates to a vehicle that may be parked illegally and, if so, execution continues with S340; otherwise, execution continues with S370. The check may be made through at least one database that contains information related to parking rules in one or more areas as further described hereinabove. In S340, a notification that a vehicle is potentially parked illegally is generated and sent to a second mobile device such as, for example, the mobile device 110-2. In an embodiment, the notification may be sent to, e.g., a device that is associated with the owner of the vehicle. In that embodiment, the information needed to send the notification to the vehicle owner's mobile device may be retrieved from a database (e.g., the database 140).

In S350, it is checked whether a parking authorization exists and if so, execution continues with S370; otherwise, execution continues with S360. In one embodiment, the determination whether a parking authorization exists may involve analysis of visual content such as a paid meter receipt. In another embodiment, the parking authorization may be received from external systems that provide remote parking meter payment, e.g., through a cell phone, and the like. In an embodiment, a notification is sent to the vehicle owner's mobile device, determining whether a parking authorization exists may include prompting the user of the mobile device to provide the relevant parking authorization via, e.g., an image of a parking meter receipt or an image of the parking meter itself, or any approved identification for an authorized parking.

In S360, a citation is generated and sent. The citation may include, but is not limited to, the rule being violated, a proposed punishment for breaking the rule, and so on. In one embodiment, the citation may be sent directly to, e.g., the vehicle owner's mobile device. In another embodiment, citation may be sent to, e.g., a member of law enforcement for validation. Validation of potential citations is described further herein below with respect to FIG. 5. In S370, it is checked whether additional content has been captured and, if so, execution continues with S310; otherwise, execution terminates. Each one of the mobile devices 110 may be operated by law enforcement user patrolling on a vehicle, for example, a car, a bicycle, electric vehicle, scooter, and so on.

As a non-limiting example, an image of a parked car is received from a mobile device of a police officer who is on the street the car is parked on. Information illustrating that the car is in a Based on the identified information and a rule prohibiting non-handicap vehicles form parking in handicap spaces, it is determined that the information relates to a potentially illegally parked vehicle. A notification is sent to a mobile device operated by a police officer who is at the police station and has access to records of handicap parking permissions. The police officer at the police station provides confirmation that, although the car does not display handicap tags or license plates, the owner of the car is permitted to park in handicap parking spaces. Thus, no citation is generated for this car owner.

As another example, an image of a parked car is received from a mobile device of a police officer driving a motorcycle on the street the car is parked. The parked car is on-street metered parking zone where parking is restricted from 6:00 am to 6:00 pm. The captured image is image is processed. If the current time is outside of the allowed time window, a valuation citation is issued. If the current is within the allowed time window then it is checked if a parking authorization exists. For example, it is checked if the meter is paid through a remote payment system (e.g., through a parking app). If the parking authorization exists, no citation is issued. In an embodiment, if no parking authorization exists, the officer checks the parked car for a physical parking permit, and if such a permit does not exist a citation is issued.

FIG. 4 is an exemplary and non-limiting flowchart S230 illustrating determining whether a vehicle may be parked illegally according to an embodiment. In S410, information related to a suspected vehicle is retrieved or received. The information may be, but is not limited to, a still image, a video, and so on. It should information visual information captured from multiple sources can be received. For example, the visual information can be received from a mobile device, a surveillance camera placed on the street, and/or images or video clips of vehicles parked in the same street or lot as the vehicle in question.

In S420, the parked vehicle information is analyzed to determine one or more potential signs of a parking rule violation. The analysis may include, but is not limited to, using one or more image processing techniques and, more specifically, one or more optical character recognition (OCR) techniques. In an embodiment, the analysis may include correlation of visual content received from multiple resources and/or other information sources. For example, a picture of the parked vehicle is correlated with an image from surveillance camera showing the vehicle near a fire hydrant. Thus, the analysis in this example, would be that the vehicles is not parked within the allowed distance from a fire hydrant.

Potential signs of a parking violation are information that may be relevant to determining whether a parking violation has occurred and may include identifying a set of characters existing on a license plate, identifying a physical parking authorization present on or inside the vehicle, determining a location where the visual content was obtained, determining a position of the vehicle respective of one or more zones (e.g., a handicap or non-handicap parking space, a fire zone where no parking is allowed, a time-restricted time zone, and so on). For example, the analysis may include determining whether a vehicle is occupying multiple parking spaces, which may be a violation of parking rules. As another example, a vehicle lacking a handicap parking tag that is parked in a handicap parking spot may be in violation of one or more parking rules. As another example, that the vehicle is not parked within the allowed distance from a fire hydrant.

In S430, based on the identified potential signs of a parking violation, at least one parking rule is retrieved. In an embodiment, the parking rules may be retrieved from, for example, a database (e.g., the database 140). In a further embodiment, the database from which the parking rules are retrieved may be a database related to law enforcement in the location where the vehicle is parked. Parking rules may include prohibitions on activities such as, but not limited to, parking one vehicle in multiple parking spaces, parking a vehicle that is not owned by a handicapped person in a handicap spot, parking in a “permit parking only” area without the proper permit, parking a non-emergency vehicle in a fire zone, parking in a space featuring a meter without having time left on the meter, parking in a zone where parking is temporarily suspended (e.g., due to street cleaning, police investigation, etc.), various other parking rules enforced by law enforcement, combinations thereof, and so on.

In S440, it is checked whether the determined potential signs of a parking violation conflict with one or more of the retrieved parking rules. If so, execution continues with S450; otherwise, execution terminates. In an embodiment, if it is determined that there is no conflict, the vehicle may be identified as legally parked. As a non-limiting example, if a vehicle is parked in a handicap spot such that a parking rule requires a valid handicap parking tag but visual inspection of the vehicle does not yield an identification of a handicap parking tag, there is a conflict. In S450, the vehicle is identified as potentially illegally parked. In an embodiment, a notification may be sent to, for example, a mobile device (e.g., the mobile device 110) indicating that the vehicle has been identified as potentially illegally parked.

As a non-limiting example, an image of a vehicle parked in a handicap parking space is received. The existence of the handicap parking space and a handicap-indicating license plate are determined. A parking rule indicating that a person parking in a handicap space must have either a handicap parking tag or handicap license plate is obtained. It is determined that the vehicle does not conflict with the parking rule. Consequently, the vehicle is identified as legally parked.

FIG. 5 is an exemplary and non-limiting flowchart 500 illustrating validation of potential citations according to an embodiment. In S510, a potential citation is received. The citation may be received from, for example, a server (e.g., the server 130). In S520, at least one potential sign of a parking violation and at least one parking rule are retrieved. In an embodiment, the image or video containing the suspected vehicle from which the potential signs of a parking violation were determined may also be retrieved. In an embodiment, visual content from the area of the parked vehicle can be received from other sources, such of surveillance cameras or pictures of vehicles parked in the same street or lot as the vehicle in question. In an embodiment, such information may be retrieved from a database (e.g., the database 140). In S530, a notification containing the potential citation, the at least one sign of a parking violation, and the at least one parking rule is sent to a parking rules enforcer. A parking rules enforcer may be, but is not limited to, a member of law enforcement, an owner of a parking lot or parking garage, and so on. Such a notification may be sent to the parking rules enforcer via a mobile device (e.g., the mobile device 110-1).

In S540, a response is received from the parking rules enforcer. The response typically includes either a confirmation that the vehicle is indeed in violation of the parking rules or a denial of the validity of the citation. In an embodiment where the citation includes a proposed punishment for the violation, the response may further include an acceptance, a denial, or a modification of the punishment. In optional S545, if the response included a modification of the punishment, the citation may be modified in accordance with the response.

In S550, it is checked whether the received response is a confirmation or modification. If so, execution continues with S560; otherwise, execution terminates. In S560, the received or modified citation is identified as valid.

As a non-limiting example, a potential citation for parking in a fire zone with a proposed punishment of a $200 fine is received. An image of a vehicle parked in a fire zone and a law prohibiting non-emergency vehicles from parking in fire zones are retrieved. The potential citation, the image, and the law are sent to a police officer. The police officer considers the information and determines that the car is only partially in the fire zone, so the police officer decides to modify the punishment to be a $50 fine. The citation is modified to reflect this new fine amount and the response is received. Since the citation was not denied, the modified citation is identified as valid.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for enforcing parking rules, comprising:
receiving, from at least one source, a captured visual content showing a suspected vehicle and at least one potential sign of an illegally parked vehicle;
identifying the at least one potential sign of an illegally parked vehicle in the captured visual content;
determining whether the suspected vehicle is parked illegally respective of the at least one potential sign of an illegally parked vehicle and at least one parking rule; and
upon determining that the suspected vehicle is parked illegally, sending a potential citation.

2. The method of claim 1, wherein determining whether the parked vehicle is parked illegally further comprises:
retrieving the at least one parking rule from a database;
determining whether the at least one potential sign of an illegally parked vehicle conflicts with the at least one parking rule; and
upon determining that the at least one potential sign of an illegally parked vehicle conflicts with the at least one parking rule, determining that the suspected vehicle is parked illegally.

3. The method of claim 1, wherein the potential citation is sent to a parking rules enforcer.

4. The method of claim 3, further comprising:
receiving a response from the parking rules enforcer respective of the sent potential citation, wherein the response comprises any of: a confirmation of the validity of the potential citation, a modification of the potential citation, and a denial of the validity of the potential citation;
determining whether the response comprised a denial of the validity of the potential citation; and
upon determining that the response did not comprise a denial of the validity of the potential citation, identifying the potential citation as valid.

5. The method of claim 4, wherein the response further comprises at least one instruction for modifying the potential citation.

6. The method of claim 5, further comprising:
modifying the potential citation; and
returning the modified potential citation.

7. The method of claim 1, wherein the captured visual content is any of: a still image, and a video clip.

8. The method of claim 1, wherein the at least one potential sign of an illegally parked vehicle is at least one of: a set of characters existing on a license plate of the suspected vehicle, a physical parking authorization that is on or inside of the suspected vehicle, and a position of the vehicle.

9. The method of claim 1, wherein the at least one parking rule is a prohibition on at least one of: parking one vehicle in multiple parking spaces, parking a non-handicap vehicle in a handicap parking space, parking in a permit parking zone without a permit, parking a non-emergency vehicle in a fire zone, parking in a parking space with a meter while there is no time left on the meter, and parking in a zone where parking is temporarily suspended.

10. A non-transitory computer-readable medium containing instructions that, when executed, perform the method of claim 1.

11. A system for enforcing parking rules, comprising:
a processor; and
a memory, the memory containing instructions that, when executed by the processor, configure the system to:
receive, from at least one source, a captured visual content showing a suspected vehicle and at least one potential sign of an illegally parked vehicle;
identify the at least one potential sign of an illegally parked vehicle in the captured visual content;
determine whether the suspected vehicle is parked illegally respective of the at least one potential sign of an illegally parked vehicle and at least one parking rule; and
upon determination that the suspected vehicle is parked illegally, send a potential citation.

12. The system of claim 11, wherein determining whether the parked vehicle is parked illegally further comprises:
retrieving the at least one parking rule;
determining whether the at least one potential sign of an illegally parked vehicle conflicts with the at least one parking rule; and
upon determining that the at least one potential sign of an illegally parked vehicle conflicts with the at least one parking rule, determining that the suspected vehicle is parked illegally.

13. The system of claim 11, wherein the potential citation is sent to a parking rules enforcer.

14. The system of claim 13, wherein the system is further configured to:
receive a response from the parking rules enforcer respective of the sent potential citation, wherein the response comprises any of: a confirmation of the validity of the potential citation, a modification of the potential citation, and a denial of the validity of the potential citation;
determine whether the response comprised a denial of the validity of the potential citation; and
upon determining that the response did not comprise a denial of the validity of the potential citation, identify the potential citation as valid.

15. The system of claim 14, wherein the response further comprises at least one instruction for modifying the potential citation.

16. The system of claim 15, wherein the system is further configured to:
modifying the potential citation; and
returning the modified potential citation.

17. The system of claim 11, wherein the captured visual content is any of: a still image, and a video clip.

18. The system of claim 11, wherein the at least one potential sign of an illegally parked vehicle is at least one of: a set of characters existing on a license plate of the suspected vehicle, a physical parking authorization that is on or inside of the suspected vehicle, and a position of the vehicle.

19. The system of claim 11, wherein the at least one parking rule is a prohibition on any of: parking one vehicle in multiple parking spaces, parking a non-handicap vehicle in a handicap parking space, parking in a permit parking zone without a permit, parking a non-emergency vehicle in a fire zone, parking in a parking space with a meter while there is no time left on the meter, parking in a zone where parking is temporarily suspended, and a combination thereof.
